(19) United States
(12) Patent Application Publication
(10) Pub. No.: US 2026/0014559 A1
(43) Pub. Date: Jan. 15, 2026

(54) PIPETTE INTERFACE SYSTEMS AND METHODS FOR VISCOUS FLUID INJECTION

(71) Applicant: Xellar Ltd., Grand Cayman (KY)

(72) Inventors: Xin Xie, Lexington, MA (US); Xiaohua Qian, Sudbury, MA (US); Hardeep Singh, Arlington, MA (US)

(73) Assignee: Xellar Ltd., Grand Cayman (KY)

(21) Appl. No.: 19/092,419

(22) Filed: Mar. 27, 2025

Related U.S. Application Data
(63) Continuation of application No. PCT/US2023/025754, filed on Jun. 20, 2023.
(60) Provisional application No. 63/412,174, filed on Sep. 30, 2022.
(60) Provisional application No. 63/412,273, filed on Sep. 30, 2022.
(60) Provisional application No. 63/412,279, filed on Sep. 30, 2022.
(60) Provisional application No. 63/437,954, filed on Jan. 9, 2023.
(60) Provisional application No. 63/437,955, filed on Jan. 9, 2023.

(51) Int. Cl. B01L 3/00

(52) U.S. Cl. CPC B01L 3/502715; B01L 2200/027; B01L 2200/0642; B01L 2300/0816

(57) ABSTRACT

The present disclosure generally relates to microfluidics, and to systems and methods for controlling the introduction of fluids. For example, certain aspects are generally directed to microfluidic devices having ports able to direct the end of a pipette tip into an end portion that is sized so as to allow fluid to flow from the pipette tip into an exit fluidly connected to a microfluidic channel. For example, the port may have a tapered portion that directs the pipette tip to the end portion. The end portion may be sized such that it is difficult for fluid to backflush around the pipette tip, and thus, the fluid is able to flow into microfluidic channels within the device, e.g., without resulting in excessive fluid remaining within the end portion. Other aspects are generally directed to methods of making or using such microfluidic devices, kits including such microfluidic devices, and the like.

### RELATED APPLICATIONS

This application claims the benefit of U.S. Provisional Patent Application Ser. No. 63/412,174, filed Sep. 30, 2022, entitled “Microfluidic Devices Containing Hydrogels, and Techniques for Making and Using”; U.S. Provisional Patent Application Ser. No. 63/412,273, filed Sep. 30, 2022, entitled “Methods and Systems for Functionalizing Surfaces for Microfluidic Devices or Other Applications”; U.S. Provisional Patent Application Ser. No. 63/412,279, filed Sep. 30, 2022, entitled “Techniques and Systems for Creating Spatially Controlled Fluidic Flows in Surface Functionalized Microfluidic Devices”; U.S. Provisional Patent Application Ser. No. 63/437,954, filed Jan. 9, 2023, entitled “Edge Effect Systems and Methods for Functionalized Microfluidic Devices”; and U.S. Provisional Patent Application Ser. No. 63/437,955, filed Jan. 9, 2023, entitled “Pipette Interface Systems and Methods for Viscous Fluid Injection.” Each of these is incorporated herein by reference in its entirety.

### FIELD

The present disclosure generally relates to microfluidics, and to systems and methods for controlling the introduction of fluids.

### BACKGROUND

At the microfluidic scale, the behavior of fluid flow is often different than at more common length scales. Factors such as surface tension, energy dissipation, and fluidic resistance become dominant, and it can be difficult to move fluids from one location to another. For example, when a fluid moves from a larger system into a microfluidic channel, differences in fluidic resistance due to the sizes or cross-sectional dimensions of the channels may become important. If the size differences are too large, the change in fluidic resistance may cause the fluid to backflush, rather than flowing into the microfluidic channel. Thus, for example, it can be difficult to transfer fluid from a pipette tip into a microfluidic channel, and accordingly, improvements are needed.

### SUMMARY

The present disclosure generally relates to microfluidics, and to systems and methods for controlling the introduction of fluids. The subject matter of the present disclosure involves, in some cases, interrelated products, alternative solutions to a particular problem, and/or a plurality of different uses of one or more systems and/or articles.

One aspect is generally directed to an article. In one set of embodiments, the article comprises a microfluidic device, defining a port configured and arranged to admit a pipette tip, the port having an opening having a diameter of between 2.5 mm and 4 mm, a substantially cylindrical end portion having a base opposite the opening of the port and a diameter of between 0.8 mm and 1 mm, and a tapered portion positioned between the opening and the end portion defining a slope of between 30° and 80° relative to the base. In some embodiments, an exit in contact with the end portion is in fluidic communication with a microfluidic channel defined within the microfluidic device, the microfluidic channel having a maximum cross-sectional dimension that is between 0.4 mm and 0.6 mm and being less than the diameter of the end portion.

Another aspect is generally directed to a method. In one set of embodiments, the method comprises inserting a pipette tip into an opening of a port of a microfluidic device configured and arranged to admit the pipette tip, where the end of the pipette tip is directed by a tapered portion within the port into a substantially cylindrical end portion of the port having a base opposite the opening of the port and a cross-sectional diameter that is bigger than the diameter of the pipette tip by no more than 0.2 mm; and flowing a fluid into the end portion. In some embodiments, at least 80 vol % of the fluid flows through an exit in contact with the end portion of the port into a microfluidic channel within the microfluidic device, the microfluidic channel having a maximum cross-sectional dimension that is smaller than a diameter of the end portion by no less than 0.5 mm.

In another set of embodiments, the method comprises inserting a pipette tip into an opening of a port of a microfluidic device configured and arranged to admit the pipette tip, where the end of the pipette tip is directed by a tapered portion within the port into an end portion of the port having a base opposite the opening of the port; flowing a fluid into the end portion, wherein the fluid flows through an exit in contact with the end portion into a microfluidic channel within the microfluidic device; and removing the pipette tip from the port such that, upon removal, the port contains no more than 0.2 mm³ of the fluid.

In another aspect, the present disclosure encompasses methods of making one or more of the embodiments described herein, for example, ports and other systems for controlling the introduction of fluids. In still another aspect, the present disclosure encompasses methods of using one or more of the embodiments described herein, for example, ports and other systems for controlling the introduction of fluids.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 illustrates a port in accordance with one embodiment;

FIG. 2 illustrates a common interconnect region, in accordance with another embodiment;

FIG. 3 illustrates a common interconnect region having three microfluidic channels, in yet another embodiment;

FIG. 4 illustrates an example device having three microfluidic channels, in still another embodiment; and

FIG. 5 illustrates microfluidic channels meeting at a common interconnect region, in accordance with certain embodiments.

### DETAILED DESCRIPTION

The present disclosure generally relates to microfluidics, and to systems and methods for controlling the introduction of fluids. For example, certain aspects are generally directed to microfluidic devices having ports able to direct the end of a pipette tip into an end portion that is sized so as to allow fluid to flow from the pipette tip into an exit fluidly connected to a microfluidic channel. For example, the port may have a tapered portion that directs the pipette tip to the end portion. The end portion may be sized such that it is difficult for fluid to backflush around the pipette tip, and thus, the fluid is able to flow into microfluidic channels within the device, e.g., without resulting in excessive fluid remaining within the end portion.

Other aspects are generally directed to methods of making or using such microfluidic devices, kits including such microfluidic devices, and the like.

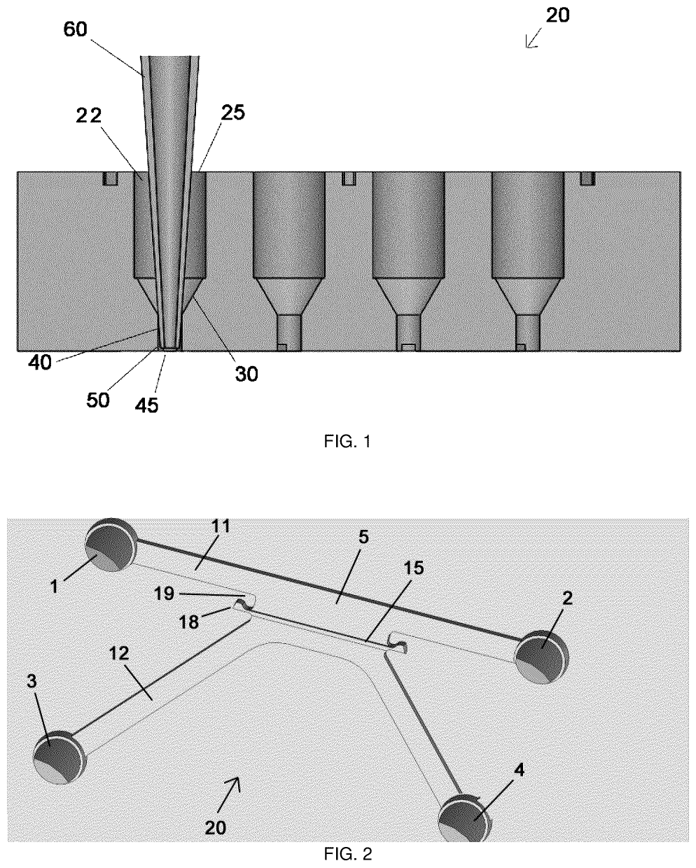

In accordance with certain aspects, one non-limiting example for transferring a fluid from a pipette tip into a microfluidic channel is now described with reference to FIG. 1. In this figure, microfluidic device 20 includes a series of ports, including port 22 and an exit 50, where a fluid is to be transferred from pipette tip 60 into a microfluidic channel. The fluid may be an aqueous fluid, a fluid containing a gel precursor, or any other suitable fluid.

In this example, pipette tip 60 is directed downwardly into port 22 through opening 25 towards the base 45 of port 22, where end portion 40 is. The size of end portion 40, in this figure, is only slightly larger than the end of pipette tip 60, and thus, it can be difficult to accurately position the end of pipette tip 60 into end portion 40. To facilitate this process, sloped portion 30 can be used to guide pipette tip 60 down into end portion 40 as it travels through port 22. The sides of the sloped portion can be at any suitable angle, e.g., to facilitate the movement of the pipette tip 60. For instance, the angle may be about 60°, about 70°, or any other suitable angle relative to base 45.

Once pipette tip 60 is positioned within end portion 40, as shown in this figure, fluid may be expelled from pipette tip 60 into the end portion. The fluid may be any fluid, including water, saline, or other fluids, e.g., having increased viscosities. Preferably, most of the fluid is able to enter exit 50 to flow into a microfluidic channel (not shown in this figure), rather than backflushing up the sides of the pipette tip and out of end portion 40 towards the opening of port 22. This may depend, at least in part, on the relative resistances to fluid flow between the pathway towards the microfluidic channel and the backflushing pathway out of end portion 40 towards the opening of port 22.

In certain cases, such as is shown in FIG. 1, exit 50 for fluid to exit may be positioned within end portion 40, and in some cases, such that it contacts base 45 of end portion 40. In some cases, the size of the exit opening may be sized so as to present a relatively small fluid resistance, such that fluid can flow into a microfluidic channel, for example, due to pressure exerted on the fluid (for instance, as it is pushed out of the pipette tip 60), and/or due to capillary action, etc. As a non-limiting example, if the microfluidic channel has a cross-sectional dimension of about 0.5 mm, then the exit may have a generally comparable cross-sectional dimension, e.g., a cross-sectional dimension of less than 1 mm, etc.

It should be understood, however, that the above discussion is by way of example only, and that other embodiments are also possible. For example, certain aspects such as discussed herein are generally directed to other systems and methods for controlling the introduction of fluids, e.g., within microfluidic devices.

For example, certain aspects are generally directed to ports contained within microfluidic devices, or other devices, able to admit a pipette tip. The pipette tip may be, for example, a 1000 microliter pipette tip, a 200 microliter pipette tip, a 10 microliter pipette tip, or the like. Other sizes are also possible. Many such pipette tips are readily available commercially. In addition, a variety of mechanisms may be used to control fluid in the pipette tip, e.g., to be passed into the microfluidic device. Examples include, but are not limited to, pneumatic pressure or piston-controlled systems, mechanical or manual action, or the like. The pipetting may also be performed manually, or automatically, e.g., using a liquid-handling robot.

The pipette may be inserted into a port of a substrate, such as a microfluidic device. Non-limiting examples of microfluidic devices include any of those described herein, as well as those described in U.S. Pat. Apl. Ser. Nos. 63/412,174, 63/412,273, and 63/412,279, each incorporated herein by reference in its entirety. The port, in one set of embodiments, may be sized so as to admit a pipette tip, e.g., such as any of those described herein. For example, in some embodiments, the port may include an opening having a diameter of less than 10 mm, less than 9 mm, less than 8 mm, less than 7 mm, less than 6 mm, less than 5 mm, less than 4.5 mm, less than 4 mm, less than 3.5 mm, less than 3 mm, less than 2.9 mm, less than 2.8 mm, less than 2.7 mm, less than 2.6 mm, less than 2.5 mm, less than 2.4 mm, less than 2.3 15 mm, less than 2.2 mm, less than 2.1 mm, less than 2 mm, less than 1.8 mm, less than 1.6 mm, less than 1.5 mm, less than 1.4 mm, less than 1.2 mm, less than 1 mm, less than 0.8 mm, less than 0.7 mm, less than 0.6 mm, less than 0.5 mm, less than 0.4 mm, etc. In addition, in some cases, the opening may have a diameter of at least 0.4 mm, at least 0.5 mm, at least 0.6 mm, at least 0.7 mm, at least 0.8 mm, at least 1 mm, at least 1.2 mm, at least 1.4 mm, at least 1.5 20 mm, at least 1.6 mm, at least 1.8 mm, at least 2 mm, at least 2.1 mm, at least 2.2 mm, at least 2.3 mm, at least 2.4 mm, at least 2.5 mm, at least 2.6 mm, at least 2.7 mm, at least 2.8 mm, at least 2.9 mm, at least 3 mm, at least 3.5 mm, at least 4 mm, at least 4.5 mm, at least 5 mm, at least 6 mm, at least 7 mm, at least 8 mm, at least 9 mm, etc. Combinations of any of these are also possible in certain embodiments, e.g., the port may have an opening having a 25 diameter of between 2.5 mm and 3 mm, between 2 mm and 2.5 mm, between 4 mm and 4.5 mm, between 2.5 mm and 4 mm, between 2.6 mm and 2.8 mm, between 8 mm and 10 mm, between 0.7 mm and 0.8 mm, between 0.6 mm and 0.7 mm, etc. In addition, in certain embodiments, the port may have an opening that is comparable to the opening of the wells on an ANSI standard microwell-plate, e.g., a 96-well plate, a 384-well plate, or a 1,536-well plate, etc. The opening may be circular, or have other shapes in some cases. If more than one port is present, then the ports may independently be of the same or different sizes.

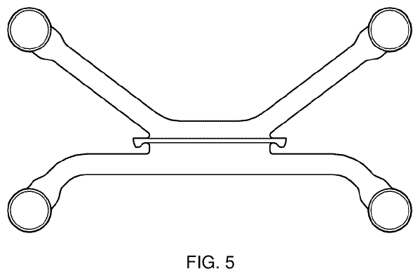

In some cases, the port may have a diameter or other opening that is larger than that of the cross-sectional dimension of the microfluidic channel, and thus there may be a tapered or funnel region between the microfluidic channel and the port region. The tapering may be linear or non-linear. A non-limiting example of funnel regions are shown in FIG. 5, with funnel regions located between the microfluidic channels and the various ports, which may be used as either inlets or outlets in various embodiments.

However, it should be understood that such funnel regions are not necessarily required, and in some embodiments, there may not be a funnel region between a port and a microfluidic channel in a device. In addition, in some embodiments, some locations in a device may contain such funnel regions, while other locations may not contain such funnel regions.

The opening of the port may allow access to an open portion, which connects to a tapered portion that connects to an end portion in accordance with one set of embodiments. This configuration may be useful to allow a pipette tip entering through the opening to be guided to the end portion, as discussed herein. In one set of embodiments, the open portion is relatively large compared to the size of the pipette tip, and may have a size or dimension that is comparable to the size or dimensions of the opening. The open portion may be substantially cylindrical, or the open portion may be gently tapered in some embodiments. For example, in some cases, the sides of the open portion may be at 90° relative to the opening (i.e., perpendicular), or the sides may be angled, e.g., such that the open portion narrows away from the opening. For example, the sides may have an inward slope of at least 75°, at least 80°, at least 82°, at least 84°, at least 85°, at least 86°, at least 87°, at least 88°, at least 89°, etc. In addition, the slope may be constant, or may change in certain embodiments.

As mentioned, one set of embodiments, the tapered portion may be sloped so as to guide a pipette tip passing through the opening to be guided into the end portion, and/or so as to allow liquids to flow through the tapered portion into the end portion. Such tapered portions can be fabricated using injection molding techniques, or other techniques such as those described herein. The end portion may have a size or a cross-sectional dimensions that is substantially smaller than the opening of the port, and the tapered portion may connect the two portions. The tapered portion may have a constant slope, or the slope may vary in certain embodiments. In some cases, the tapered portion is circularly symmetric, e.g., about an axis perpendicular to the opening.

In certain cases, for example, the tapered portion may have an angle, relative to the opening or the base of the end portion, of at least 30°, at least 35°, at least 40°, at least 45°, at least 50°, at least 55°, at least 60°, at least 65°, at least 70°, at least 75°, at least 80°, at least 85°, etc. In addition, in some cases, the tapered portion may have an angle of no more than 85°, no more than 80°, no more than 75°, no more than 70°, no more than 65°, no more than 60°, no more than 55°, no more than 50°, no more than 45°, no more than 40°, no more than 35°, etc. Combinations of any of these are also possible, e.g., the angle may be between 300 and 85°, between 60° and 70°, between 30° and 40°, between 50° and 75°, between 60° and 80°, etc.

In some cases, the tapered portion may have height of at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm, at least 1.5 mm, at least 2 mm, at least 3 mm at least 4 mm, at least 5 mm, etc., and/or a height of no more than 5 mm, no more than 4 mm, no more than 3 mm, no more than 2 mm, no more than 1.5 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, no more than 0.2 mm, no more than 0.1 mm, etc. Combinations of any of these are also possible in accordance with certain embodiments. For instance, the height of the tapered portion may be between 0.4 mm and 0.6 mm, between 1 mm and 2 mm, between 0.7 mm and 1 mm, etc.

As noted, the tapered portion may help to direct the pipette tip into an end portion of the device. The end portion, in one set of embodiments, may be sized so as to allow the pipette tip to fit within, but without too much clearance. For example, the end portion may be sized such that it is difficult for fluid to backflush around the pipette tip, and thus, the fluid is able to flow into an exit to reach microfluidic channels within the device. In addition, in some cases, the clearance between the end portion and the pipette tip may be sufficiently small so as to prevent an excessive amount of fluid remaining within the end portion.

For example, in one set of embodiments, the volume of space in the end portion of the device outside of the pipette tip, once a pipette tip has been fully inserted into the end portion (e.g., contacting the base of the end portion), may be no more than 10 mm³, no more than 7 mm³, no more than 5 mm³, no more than 4 mm³, no more than 3 mm³, no more than 2 mm³, no more than 1 mm³, no more than 0.5 mm³, no more than 0.3 mm³, no more than 0.2 mm³, or no more than 0.1 mm³. In some cases, fluid may be prevented from backflushing up out of the end portion into the rest of the port, e.g., due to the relatively low clearance between the end portion and the pipette tip, and thus the amount of fluid that remains in the end portion, once the pipette tip has been removed, may be relatively minimal, e.g., with residual volumes less than these.

In certain embodiments, the average distance between the pipette tip and the walls of the end portion may be no greater than no greater than no greater than 0.5 mm, no greater than 0.4 mm, no greater than 0.3 mm, no greater than 0.2 mm, no greater than 0.1 mm, no greater than 0.05 mm, etc.

Thus, in some cases, at least 50 vol % of the fluid entering the end portion from the pipette tip may pass through the exit. In some cases, at least 60 vol %, at least 70 vol %, at least 75 vol %, at least 80 vol %, at least 85 vol %, at least 90 vol %, or at least 95 vol % of the fluid entering the end portion from the pipette tip may pass through the exit.

The end portion may have a cylindrical shape, e.g., with a circular cross-section, or other shapes in certain cases. In some embodiments, the end portion may have a diameter or a maximum cross-sectional dimension (e.g., orthogonal to the opening of the port) of at least at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm, at least 1.5 mm, at least 2 mm, at least 3 mm at least 4 mm, at least 5 mm, etc., and/or no more than 5 mm, no more than 4 mm, no more than 3 mm, no more than 2 mm, no more than 1.5 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, no more than 0.2 mm, no more than 0.1 mm, etc. Combinations of any of these are also possible in accordance with certain embodiments. For example, the diameter or maximum cross-sectional dimension of the end portion may be between 0.8 mm and 1 mm.

In some cases, the end portion may have height of at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm, at least 1.5 mm, at least 2 mm, at least 3 mm at least 4 mm, at least 5 mm, etc., and/or a height of no more than 5 mm, no more than 4 mm, no more than 3 mm, no more than 2 mm, no more than 1.5 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, no more than 0.2 mm, no more than 0.1 mm, etc. Combinations of any of these are also possible in accordance with certain embodiments. For instance, the height of the end portion may be between 0.4 mm and 0.6 mm, between 1 mm and 2 mm, between 0.7 mm and 1 mm, etc.

In some embodiments, there may be an exit in contact with the end portion to allow fluid to exit the end portion to reach one or more microfluidic channels. In one set of embodiments, the exit may be in contact with the base of the end portion. In addition, in some embodiments, the exit may be positioned in any suitable location so as to allow fluid from the pipette tip to flow into the microfluidic device, e.g., to reach one or more microfluidic channels such as those disclosed herein.

The exit may have any suitable shape or size. In some cases, the exit may be substantially circular, square, or rectangular. The exit may have a maximum cross-sectional dimension of no more than 2 mm, no more than 1.5 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, no more than 0.2 mm, no more than 0.1 mm, etc. In some cases, the exit may have a maximum cross-sectional dimension of at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm, at least 1.5 mm, at least 2 mm, etc. Combinations of any of these are also possible in certain cases. For example, the exit may have a maximum cross-sectional dimension of between 0.8 mm and 1 mm, between 0.4 mm and 0.6 mm, between 0.7 mm and 1 mm, or the like.

In addition, in some cases, the exit may have a maximum cross-sectional dimension that is greater than a microfluidic channel in fluidic communication with the exit. However, in some cases, the exit may have a maximum cross-sectional dimension that is no greater than 1 mm, no greater than 0.9 mm, no greater than 0.8 mm, no greater than 0.7 mm, no greater than 0.6 mm, no greater than 0.5 mm, no greater than 0.4 mm, no greater than 0.3 mm, no greater than 0.2 mm, or no greater than 0.1 mm than the maximum cross-sectional dimension of the microfluidic channel.

The exit may be in fluid communication with any of a variety of microfluidic channels in one set of embodiments. The microfluidic channels within the microfluidic device may have any configuration within the device, and there may be one or more than one such channel, which may independently be the same or different. A microfluidic channel may have any cross-sectional shape (circular, oval, triangular, irregular, square or rectangular, or the like) and can be covered or uncovered. The microfluidic channels may be used to move or process fluid within the substrate in any of a number of ways, for example, to allow fluids to flow from one or more inlets, through the microfluidic channel, to one or more outlets.

In some cases, a microfluidic channel may have a maximum cross-sectional dimension of less than 10 mm, less than 8 mm, less than 7 mm, less than 6 mm, less than 5 mm, less than 3 mm, less than 2 mm, and in certain cases, less than 1 mm, less than 500 micrometers, less than 300 micrometers, less than 200 micrometers, less than 100 micrometers, less than 50 micrometers, less than 30 micrometers, less than 20 micrometers, less than 10 micrometers, less than 5 micrometers, etc. In addition, a microfluidic channel may have a maximum cross-sectional dimension of at least 5 micrometers, at least 10 micrometers, at least 20 micrometers, at least 30 micrometers, at least 50 micrometers, at least 100 micrometers, at least 200 micrometers, at least 300 micrometers, at least 500 micrometers, at least 1 mm, at least 2 mm, at least 3 mm, at least 5 mm, at least 6 mm, at least 7 mm, at least 8 mm, at least 10 mm, etc. Any combination of these is also possible. For instance, a microfluidic channel may have a maximum cross-sectional dimension of between 10 micrometers and 30 micrometers, between 300 micrometers and 1 mm, or the like. In one embodiment, for example, the microfluidic channel may have a maximum cross-sectional dimension of between 100 micrometers and 500 micrometers.

In some embodiments, the microfluidic channel may have a maximum cross-sectional dimension that is smaller than the diameter of the pipette tip. However, in certain cases, the microfluidic channel having a maximum cross-sectional dimension that is smaller than the diameter of the pipette tip by no less than 1 mm, no less than 0.9 mm, no less than 0.8 mm, no less than 0.7 mm, no less than 0.6 mm, no less than 0.5 mm, no less than 0.4 mm, no less than 0.3 mm, no less than 0.2 mm, or no less than 0.1 mm.

In one set of embodiments, fluid may flow from the pipette tip into the end portion, and then into one or more microfluidic channels. The fluid may enter the microfluidic channels through a variety of mechanisms, including capillary flow, gravitational forces, or the like. In some embodiments, the fluid may exit the pipette tip due to pressure, for example, applied to a pipette connected to the pipette tip. The pressure may be, for example, pneumatic pressure or piston-controlled, and may be mechanically, manually, or automatically applied, for example, using a liquid-handling robot such as may be obtained commercially.

In addition, in certain embodiments, as mentioned, the end portion and the exit may be sized to make it difficult for fluid to backflush around the pipette tip, and instead facilitate the flow of fluid through the exit into one or more microfluidic channels within the device, e.g., without resulting in excessive fluid remaining within the end portion. In some cases, the fluid resistances of the exit and/or the microfluidic channels may be less than the fluid resistance for fluid flow backflushing around the pipette tip, which may facilitate the flow of fluid into the microfluidic channels therein. In some cases, for instance, the dimensions of the exit and/or the microfluidic channels may be comparable to the dimensions of the opening of the pipette tip, e.g., to promote the flow of fluid into the microfluidic channels.

It should be noted that this may be particularly useful, according to some embodiments, for fluids that are relatively viscous. While any fluids may be used, e.g., aqueous fluids such as water or saline, etc., in some cases, relatively viscous fluids may be used, e.g., introduced via a pipette tip. For instance, the fluid may have a viscosity of at least 1 cP, at least 1.1 cP, at least 1.2 cP, at least 1.3 cP at least 1.5 cP, at least 2 cP, at least 3 cP, at least 5 cP, at least 10 cP, at least 30 cP, at least 50 cP, at least 100 cP, at least 300 cP, at least 1,000 cP, at least 3,000 cP, at least 10,000 cP, etc. For instance, the fluid may contain a hydrogel (or other scaffold medium) precursor, e.g., such as discussed herein, which may be introduced into one or more microfluidic channels and hardened therein, e.g., to form a hydrogel. For example, the precursor may be hardenable to form a hydrogel such as collagen, Matrigel®, or others such as any of those described herein.

Thus, as mentioned, certain aspects of the present disclosure are generally directed to microfluidic devices containing such ports. Such microfluidic devices can be formed using injection molding, or other techniques such as those described herein. The microfluidic device may have one or more microfluidic channels defined in a substrate. The substrate may have any suitable shape or configuration, including square, rectangular, circular, etc. In some cases, the substrate may include one or more layers of material. In certain cases, one or more layers of the substrate may be formed out of materials such as pressure-sensitive adhesives, or other materials, including any of those described herein. For instance, the microfluidic device may include one, two, three, four, or more layers, and one or more of the layers may contain or define one or more microfluidic channels therein. The layers can be bonded together using a variety of techniques, such as using pressure sensitive adhesives, or by thermal bonding, laser welding, etc. In addition, in some cases, larger channels, tubes, chambers, reservoirs, fluidic pathways, etc. may also be defined within a substrate, e.g., using one or more layers.

In some cases, all of the channels within a substrate or a layer may be microfluidic channels. However, in other cases, larger channels, tubes, chambers, reservoirs, fluidic pathways, etc. may also be present. Those of ordinary skill in the art will be familiar with microfluidic channels and systems and methods of making substrates containing microfluidic channels (and/or other channels).

In one set of embodiments, two, three, four, five, or more microfluidic channels may meet at a common interconnect region. In some cases, some or all of the microfluidic channels may be positioned to be parallel to each other within the common interconnect region, and in some cases, no physical barrier (e.g., pillars, columns, bumps, phaseguides, ridges, etc.) may be present within the common interconnect region that partially or completely separates the microfluidic channels from each other. Thus, for example, a fluid could flow from one channel within the common interconnect region to another channel within the common interconnect region if both channels were empty.

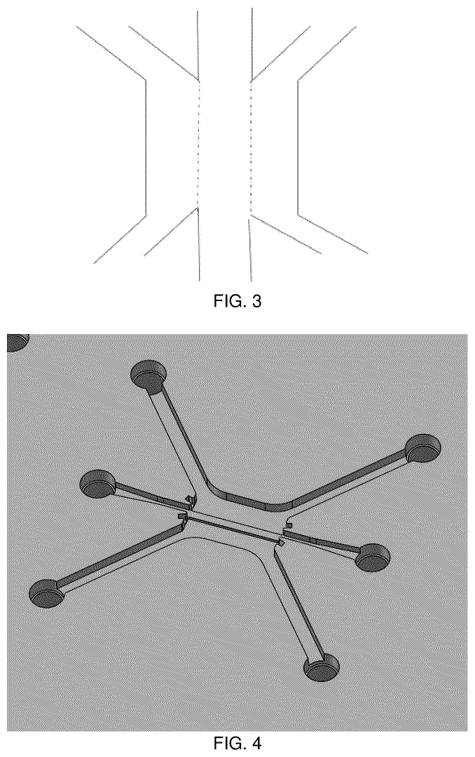

Non-limiting examples of a common interconnect region with two microfluidic channels are shown in FIGS. 2 and 5, while non-limiting examples of a common interconnect region with three microfluidic channels are shown in FIGS. 3 and 4. The common interconnect region in some cases, may be treated as a microfluidic channel portion that is composed of two or more microfluidic channels that are in fluidic contact with each other and are generally positioned parallel to each other within the region, although the microfluidic channels may not necessarily be parallel outside of the common interconnect region. In a common interconnect region, the channels are not separated (e.g., by physical barriers such as pillars, columns, bumps, phaseguides, ridges, etc.), and the microfluidic channels can come into contact with each other such that the microfluidic channels in fluidic contact, e.g., to allow fluid flow between channels to occur within the common interconnect region. For example, a first microfluidic channel may have a first inlet and a first outlet, and a second microfluidic channel may have a second inlet and a second outlet, and the first and second microfluidic channels may come into contact and be positioned parallel to each other within the common interconnect region between their respective inlets and outlets (although outside of the common interconnect region, they may or may not also be parallel).

In FIG. 2, between inlet 1 and outlet 2 is first microfluidic channel 11, while between inlet 3 and outlet 4 is second microfluidic channel 12. In some cases, the inlets may be constructed and arranged to guide pipet tips towards the microfluidic channels, e.g., as discussed herein. First microfluidic channel 11 may be filled with a hydrogel or another scaffold medium, while second microfluidic channel 12 may be empty, e.g., such that during use of the microfluidic device, a fluid (e.g., cell media) can flow from inlet 3 to outlet 4 (or vice versa in some cases). This may be used, for example, to perfuse the cells within the microfluidic device, for example, contained on or within the hydrogel within first microfluidic channel 11.

In this figure, first microfluidic channel 11 and second microfluidic channel 12 come into fluidic contact via common interconnect region 5, e.g., such that a fluid could flow from one channel to the other if both channels were empty. In this region, first microfluidic channel 11 and second microfluidic channel 12 are positioned parallel to each other, e.g., such that there is no physical barrier that partially or completely separates the microfluidic channels from each other within the common interconnect region. For example, no pillars, columns, or other barriers may be present that separates first microfluidic channel 11 and second microfluidic channel 12.

Also shown here is trench 15, which may be positioned between first microfluidic channel 11 and second microfluidic channel 12 within common interconnect region 5. As discussed in more detail below, a trench may be positioned between a microfluidic channel and a second microfluidic channel, e.g., within a common interconnect region, for example, such as is shown here. The trench may be used in certain embodiments to separate or inhibit the flow of fluid from one microfluidic channel to another within the common interconnect region. Such a configuration may allow for separation of fluids to occur within the common interconnect region while avoiding the use of pillars, columns, bumps, phaseguides, ridges, or other barriers that may partially or completely block the common interconnect region. For instance, barriers that at least partially block the first microfluidic channel and the second microfluidic channel may also inhibit the ability of cells to access the cell media (e.g., to access nutrients, remove waste, etc.), and/or make it more difficult to study cells within the microfluidic device, etc., e.g., by making imaging of the cells more difficult. However, it should be understood that in other embodiments, a trench may be used in conjunction with pillars, columns, bumps, phaseguides, ridges, or other barriers.

As a non-limiting example, as discussed herein, a first microfluidic channel may contain a hydrogel or other scaffold medium, while a second microfluidic channel may contain a fluid (e.g., cell media), and within the common interconnect region, the fluid is able to come into direct contact with the hydrogel or other scaffold medium, e.g., without having to circumvent a physical barrier, such as a pillar or a column. Accordingly, in certain embodiments, there may be a barrierless interface in a common interconnect region between a first fluid or medium in a first microfluidic channel (for example, a hydrogel or other scaffold medium), and a second fluid or medium in a second microfluidic channel (for example, cell media). For instance, in some embodiments, no interface material or physical barrier separating the first fluid or medium from the second fluid or medium may be present. Thus, for example, a hydrogel or other scaffold medium may partially fill the common interconnect region, for example, such that at least 20%, at least 30%, at least 40%, at least 50%, at least 60%, at least 70%, at least 80%, and/or no more than 80%, no more than 70%, no more than 60%, no more than 50%, no more than 40%, no more than 30%, or no more than 20% of any cross-section of the common interconnect region is not filled with the hydrogel or other scaffold medium. In some embodiments, the hydrogel (or other scaffold medium) partially fills the common interconnect region such that the hydrogel does not prevent bulk fluid flow through at least a portion of the common interconnect region.

In certain embodiments, the hydrogel (or other coating material) may be substantively contained within a microfluidic channel, e.g., within a common interconnect region having other microfluidic channels, for example, without the hydrogel being blocked due to pillars, columns, bumps, phaseguides, ridges, or other physical barriers. However, it should be understood that in other embodiments, a hydrogel (or other coating material) may be used in conjunction with pillars, columns, bumps, phaseguides, ridges, or other barriers.

In one set of embodiments, two or more microfluidic channels within a common interconnect region may be separated using a trench, e.g., on or in a wall of the common interconnect region. Non-limiting examples of trenches include those described in U.S. Pat. Apl. Ser. No. 63/412,279, filed on Sep. 30, 2022, entitled “Techniques and Systems for Creating Spatially Controlled Fluidic Flows in Surface Functionalized Microfluidic Devices,” incorporated herein by reference. Additional non-limiting examples of trenches are shown in FIGS. 4 and 5.

More than one trench may also be present in some cases, e.g., on opposed surfaces within the common interconnect region. Without wishing to be bound by any theory, it is believed that a fluid flowing in a channel may be attracted to a channel surface, e.g., due to similar hydrophilicities (e.g., if both are relatively hydrophilic or hydrophobic) and/or capillary action, which may facilitate the flow of the fluid within the channel. However, it may be difficult in certain embodiments for such a fluid to be able to cross a trench, e.g., if the volume of fluid is not too great. For example, the trench may exhibit a different hydrophilicity (e.g., one that does not promote attraction with the fluid), and/or the shape of the trench may discourage the fluid from being able to cross, e.g., due to the dimensions of the trench. In some embodiments, the trench may facilitate the flow of fluid through one channel within the common interconnect region, for example, without the fluid flowing into another channel within the common interconnect region. In addition, in certain embodiments, the trench may be treated, e.g., as discussed herein, to render it more hydrophilic or hydrophobic. For example, a coating material, such as a hydrophobic polymer, may be coated on at least a portion of the trench.

In some aspects, a trench may include features that are able to at least partially prevent fluid from crossing the trench. Examples of such trenches may be seen in a provisional patent application filed on Jan. 9, 2023, entitled “Edge Effect Systems and Methods for Functionalized Microfluidic Devices,” U.S. Ser. No. 63/437,954, incorporated herein by reference in its entirety. Without wishing to be bound by any theory, it is believed that under certain conditions, a fluid may be able pass over the trench by clinging to the edges or ends of the trench that are positioned between the channels, for example, due to surface tension or edge effects. Accordingly, even though a trench can be used to prevent fluid from crossing from one channel to another within the common interconnect region, the trench may not be able to fully prevent the fluid from crossing under certain conditions.

In one set of embodiments, the microfluidic channels may have any suitable configuration. If more than one microfluidic channel is present, the channels may independently have the same or different lengths. In some cases, one or more microfluidic channels may intersect, for example, in a T, Y, or a +intersection, or within a common interconnect region such as described herein, etc. Other types of intersections are also possible. A microfluidic channel, in some cases, may be substantially straight between an inlet and an outlet. In addition, in some cases, a microfluidic channel may have one, two, or more bends, curves, or the like between an inlet and an outlet. (As a non-limiting example, as is shown in FIG. 2, microfluidic channel 12 has two bends between inlet 3 and outlet 4.) If more than one microfluidic channel is present, the microfluidic channels may independently have the same or different configurations. In some cases, there may be 0, 1, 2, or more intersections with other microfluidic channels between an inlet and an outlet of the microfluidic channel. In addition, in one set of embodiments, a microfluidic channel may pass between a single port and a microfluidic interconnect region, e.g., there may not necessarily be both an inlet and an outlet of a microfluidic channel.

In addition, in one set of embodiments, a coating material may be present on one or more walls defining a microfluidic channel, for example, to alter the hydrophilicity of the walls, although in some embodiments, no coating materials may be present. For example, the coating material may increase or decrease the hydrophilicity of at least one of the walls defining a microfluidic channel. Different walls of the microfluidic channel may independently have the same or different hydrophilicities, for example, by coating different walls with different coating materials (or no coating material). Without wishing to be bound by any theory, it should be understood that, due to the small and cramped nature of the microfluidic channels, a fluid within a microfluidic channel may interact with the walls of the microfluidic channels, which can affect the flow properties of the fluid flowing through the channel. Thus, in some embodiments, the hydrophilicities of the walls forming a microfluidic channel may affect the flow of fluid through the channel.

Non-limiting examples of polymers that may be deposited onto one or more walls of a microfluidic channel, e.g., to form a coating thereon, include polyvinylpyrrolidone (PVP), poly(ethylene glycol) (PEG), poly(vinyl alcohol) (PVA), polylysine, or the like. In addition, in some cases, the coating materials may include other materials, in addition to or instead of polymers such as these, for example, ECM attachment factor. In some cases, coating materials, including polymers such as these, may be used to alter or increase the hydrophilicity of the microfluidic channel. In some cases, the increased hydrophilicity may be determined as a change in water contact angle, or by applying 2 microliters of water to a surface of the hydrophilic coating, and measuring a spread of water onto the surface of at least 10 mm².

Non-limiting examples of hydrogels (e.g., that can be used as an extracellular matrix for cells) include collagen (e.g., Type I collagen, Type II collagen, Type III collagen, etc.), Matrigel®, methacrylated gelatin (Gel-MA), fibrin, alginate, hyaluronic acid, polyacrylamide, poly(ethylene glycol), poly(vinyl alcohol), agarose, agar, chitosan, poly(RADARADARADARADA) (PuraMatrix), poly(AEAEAKAKAEAEAKAK) (EAK16), poly(KLDLKLDLKLDL) (KLD12), or the like. In addition, more than one of these and/or other materials may be present in a hydrogel in certain instances. The collagen may arise from any suitable source, e.g., bovine collagen, rat collagen, fish (marine) collagen, chicken collagen, porcine collagen, sheep collagen, or the like. Other hydrogels will be known by those of ordinary skill in the art. In some embodiments, hydrogels such as these can be formed by flowing a fluid containing a hydrogel precursor, and causing the precursor to form the hydrogel, for example, using a change in temperature (e.g., cooling the device), exposure to ultraviolet radiation, exposure to a chemical, or the like.

In addition, other scaffold media can be used in certain embodiments, e.g., instead of or in addition to a hydrogel as discussed herein. Thus, it should be understood that hydrogels are described herein by way of example only. Non-limiting examples of other scaffold media that may be used in certain embodiments include paraffin, waxes, or the like. These may be added, for example, by flowing a fluid containing a scaffold medium precursor into a microfluidic channel within the device, and treating the precursor to form the scaffold medium within the device. For example, a paraffin or a wax may be introduced into a device at a temperature where the material is liquid, and treated (e.g., cooled) to solidify the medium within the microfluidic device.

In addition, in one set of embodiments, the scaffold medium may be substantially transparent, e.g., to allow for imaging of cells, such as is described herein. As a non-limiting example, in one embodiment, a hydrogel comprising collagen may be used.

According to one set of embodiments, the hydrogel or other scaffold medium may be exposed to cells, which may be grown or cultured on or in the hydrogel or other scaffold medium in some embodiments. Any suitable technique may be used to apply the cells. In some cases, for instance, the cells may be suspended in solution, which is flowed past the hydrogel or other scaffold medium, e.g., within the common interconnect region, and allowed to incubate there to promote attachment of the cells. In some cases, this process may occur over a period of at least 24 hours, or other suitable times. In addition, in some cases, the cells may be mixed with a fluid containing a hydrogel precursor or other scaffold medium precursor, e.g., prior to introduction to the microfluidic device. The cells may then be incubated and allowed to become embedded within the hydrogel or other scaffold medium. Those of ordinary skill in the art will be familiar with techniques for attaching cells to a suitable scaffold medium. Without wishing to be bound by any theory, it is believed that culturing cells on or in such an scaffold medium, e.g., a hydrogel, may more closely approximate the conditions that the cells naturally grow in, e.g., as opposed to a 2-dimensional surface. Accordingly, such cells may respond more similarly and appropriately when cultured in a 3-dimensional environment, such as a hydrogel.

Examples of cells that may be cultured on or in a hydrogel or other scaffold medium include, but are not limited to, mammalian cells such as human cells. Specific non-limiting examples include fibroblasts, lung cells, liver cells, fat cells, kidney cells, intestinal cells, brain cells, epithelial cells, endothelial cells, stromal cells, immune cells, or the like. In some cases, the cells may be stem cells, such as pluripotent stem cells, totipotent stem cells, multipotent stem cells, etc. Other cell types are also possible. In some cases, more than one type of cell may be present, e.g., liver cells and fibroblasts. In addition, in certain embodiments, the cells may produce organoids, tubes, or other 3-dimensional structures, e.g., depending on the cells being cultured.

In one set of embodiments, there may be a plurality of repeat units on a substrate, e.g., repeat units including one or more microfluidic channels or common interconnect regions, such as those described herein. For instance, there may be at least 3, at least 5, at least 10, at least 20, at least 30, at least 40, at least 50, at least 60, at least 70, at least 80, at least 90, at least 100, at least 150, at least 200, at least 300, at least 500, at least 1000, at least 1500, etc. repeat units on a substrate. The repeat units may be all identically oriented, or they may be differently oriented (e.g., rotated, flipped, etc.) in certain embodiments. In addition, in some cases, two, three, or more types of repeat units may be present on a substrate, e.g., having dissimilar configurations.

In some embodiments, the repeat units may be regularly arranged on a substrate. For instance, the repeat units may be arranged as a square, a rectangle, a circle, a hexagonal configuration, or the like. In addition, the repeat units may be irregularly arranged in certain cases. As an example, the repeat units may be arranged in a 2×n configuration, where n is 1, 2, 3, 4, 5, 6, 7, 8, 9, 10, or the like. As another non-limiting example, the repeat units may be arranged in a 3×n configuration, a 4×n configuration, a 6×n configuration, an 8×n configuration, a 12×n configuration, a 16×n configuration, or the like. For example, the repeat units may be arranged in a 6×6 configuration, an 8×8 configuration, or the like, a 16×16 configuration, or the like.

The microfluidic channels, according to one set of embodiments, may be contained with a substrate having dimensions comparable to a microscope slide, e.g., arranged into a plurality of repeat units on the substrate. For example, the substrate may have dimensions of 75 mm×25 mm, 75 mm×26 mm, 46 mm×28 mm, 46 mm×27 mm, 75 mm×38 mm, 76mm×51 mm, 76 mm×52 mm, etc. In some cases, such dimensions may vary somewhat (for example, by +/−1 mm, +/−2 mm, or +/−5 mm, etc.), e.g., to allow for manufacturing tolerances or the like. Such dimensions may be useful in some embodiments, e.g., to interface with laboratory equipment able to handle microscope slides.

In another set of embodiments, the microfluidic channels may be contained with a substrate having dimensions comparable to a microwell plate, e.g., one having ANSI dimensions of 128 mm×85 mm, e.g., arranged into a plurality of repeat units on the substrate. In some cases, the dimensions may vary somewhat (for example, by +/−1 mm, +/−2 mm, or +/−5 mm, etc.), e.g., to allow for manufacturing tolerances or the like. Such dimensions may be useful in some embodiments, e.g., to interface with laboratory equipment, such as plate readers or liquid handling robots that are able to handle microwell plates. In addition, in some embodiments, one or more inlets and/or outlets may be positioned within the substrate to match the locations of wells on a microwell plate, e.g., the center locations of the wells on a 24-well standard microplate, a 48-well standard microplate, a 96-well standard microplate, a 384-well standard microplate, or a 1536-well standard microplate, etc.

The substrate may be formed from any suitable materials. In some cases, the substrate may be formed from one, two, three, four, five, or more layers of materials, which may independently be the same or different. For instance, a layer within the substrate may comprise glass or a polymer. For example, the substrate may be formed using polystyrene. Other non-limiting examples of polymers include polycarbonate, polymethylmethacrylate (PMMA), polycarbonate, polypropylene, cyclic olefin polymers (COP), cyclic olefin copolymers (COC), polyethylene terephthalate (PET), or the like. For example, an outer or end layer of the substrate may comprise glass or polymer, which may be useful for protecting internal components of the microfluidic device. In addition, as discussed herein, one or more of the layers of the microfluidic channel may be chosen to be substantially transparent. The substrate can be formed using injection molding, or other techniques such as those described herein.

In addition, certain aspects are generally directed to methods of making microfluidic devices such as those described herein. Additional techniques for making microfluidic devices include those described in U.S. Pat. Apl. Ser. No. 63/412,273, filed on Sep. 30, 2022, entitled “Methods and Systems for Functionalizing Surfaces for Microfluidic Devices or Other Applications,” incorporated herein by reference.

The following are each incorporated herein by reference in their entireties: U.S. Provisional Patent Application Ser. No. 63/412,174, filed Sep. 30, 2022, entitled “Microfluidic Devices Containing Hydrogels, and Techniques for Making and Using”; U.S. Provisional Patent Application Ser. No. 63/412,273, filed Sep. 30, 2022, entitled “Methods and Systems for Functionalizing Surfaces for Microfluidic Devices or Other Applications”; U.S. Provisional Patent Application Ser. No. 63/412,279, filed Sep. 30, 2022, entitled “Techniques and Systems for Creating Spatially Controlled Fluidic Flows in Surface Functionalized Microfluidic Devices”; U.S. Provisional Patent Application Ser. No. 63/437,954, filed Jan. 9, 2023, entitled “Edge Effect Systems and Methods for Functionalized Microfluidic Devices”; and U.S. Provisional Patent Application Ser. No. 63/437,955, filed Jan. 9, 2023, entitled “Pipette Interface Systems and Methods for Viscous Fluid Injection.”

In addition, the following patent applications, filed on even date herewith, are incorporated herein by reference in their entireties: a PCT application entitled “Microfluidic Devices Containing Hydrogels, and Techniques for Making and Using”; a PCT application entitled “Methods and Systems for Functionalizing Surfaces for Microfluidic Devices or Other Applications”; a PCT application entitled “Techniques and Systems for Creating Spatially Controlled Fluidic Flows in Surface Functionalized Microfluidic Devices”; and a PCT application entitled “Edge Effect Systems and Methods for Functionalized Microfluidic Devices.”

Furthermore, the following patent applications, filed on even date herewith, are incorporated herein by reference in their entireties: a US design application entitled “Fluid Channel”; a US design application entitled “Fluid Channel Trench”; a US design application entitled “Well Plate”; a US design application entitled “Fluid Channel”; a US design application entitled “Sample Plate”; and a US design application entitled “Sample Plate Carrier.”

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
a microfluidic device, defining a port configured and arranged to admit a pipette tip, the port having an opening having a diameter of between 2.5 mm and 4 mm, a substantially cylindrical end portion having a base opposite the opening of the port and a diameter of between 0.8 mm and 1 mm, and a tapered portion positioned between the opening and the end portion defining a slope of between 30° and 80° relative to the base, wherein an exit in contact with the end portion is in fluidic communication with a microfluidic channel defined within the microfluidic device, the microfluidic channel having a maximum cross-sectional dimension that is between 0.4 mm and 0.6 mm and being less than the diameter of the end portion.

2. The article of claim 1, wherein the microfluidic device is injection-molded.

3. The article of any one of claim 1 or 2, wherein the microfluidic device comprises polystyrene

4. The article of claim 1, wherein the opening has a diameter of between 2.5 mm and 3 mm.

5. The article of claim 1, wherein the opening has a diameter of between 2.6 mm and 2.8 mm.

6. The article of claim 1, wherein the slope is between 60° and 80° relative to the base.

7. The article of claim 1, wherein the end portion has a height of less than 1 mm.

8. The article of claim 1, wherein the end portion has a height of less than 0.6 mm.

9. The article of claim 1, wherein the exit is in contact with the base.

10. The article of claim 1, wherein the exit has a maximum cross-sectional dimension of less than 1 mm.

11. The article of claim 10, wherein the exit has a maximum cross-sectional dimension of between 0.8 mm and 1 mm.

12. The article of claim 1, wherein the microfluidic channel contains a hydrogel precursor.

13. The article of claim 1, wherein the microfluidic channel contains a hydrogel.

14. The article of claim 13, wherein the hydrogel comprises collagen.

15. A method, comprising:
inserting a pipette tip into an opening of a port of a microfluidic device configured and arranged to admit the pipette tip, wherein the end of the pipette tip is directed by a tapered portion within the port into a substantially cylindrical end portion of the port having a base opposite the opening of the port and a cross-sectional diameter that is bigger than the diameter of the pipette tip by no more than 0.2 mm; and
flowing a fluid into the end portion, wherein at least 80 vol % of the fluid flows through an exit in contact with the end portion of the port into a microfluidic channel within the microfluidic device, the microfluidic channel having a maximum cross-sectional dimension that is smaller than a diameter of the end portion by no less than 0.5 mm.

16. The method of claim 15, further comprising removing the pipette tip from the port.

17. The method of claim 15, wherein upon removal of the pipette tip, the port contains no more than 0.2 mm³ of the fluid.

18. The method of claim 15, wherein the fluid comprises a hydrogel precursor, the method further comprising allowing the hydrogel precursor to form a hydrogel within the microfluidic channel.

19. (canceled)

20. The method of claim 15, wherein the fluid has a viscosity of at least 1.2 cP.

21-32. (canceled)

33. A method, comprising:
inserting a pipette tip into an opening of a port of a microfluidic device configured and arranged to admit the pipette tip, wherein the end of the pipette tip is directed by a tapered portion within the port into an end portion of the port having a base opposite the opening of the port;
flowing a fluid into the end portion, wherein the fluid flows through an exit in contact with the end portion into a microfluidic channel within the microfluidic device; and
removing the pipette tip from the port such that, upon removal, the port contains no more than 0.2 mm³ of the fluid.

34-49. (canceled)
